(19) United States
(12) Patent Application Publication
(10) Pub. No.: US 2015/0223441 A1
(43) Pub. Date: Aug. 13, 2015

(54) DEVELOPMENT OF PHEROMONE-ASSISTED TECHNIQUES (PAT) TO IMPROVE EFFICACY OF INSECTICIDE BAITS TARGETING URBAN PEST ANT SPECIES

(71) Applicant: The Regents of the University of California, Oakland, CA (US)

(72) Inventors: Dong-Hwan CHOE, Riverside, CA (US); Kevin Welzel, Riverside, CA (US); Les Greenberg, Riverside, CA (US); John Klotz, Riverside, CA (US)

(73) Assignee: The Regents of the University of California, Oakland, CA (US)

(21) Appl. No.: 14/621,989

(22) Filed: Feb. 13, 2015

Related U.S. Application Data
(60) Provisional application No. 61/939,421, filed on Feb. 13, 2014.

(51) Int. Cl. A01M 1/02; A01M 1/20

(52) U.S. Cl. CPC A01M 1/02; A01M 1/2005; A01M 1/2011

(57) ABSTRACT

A method and system of improving efficacy of an ant bait are disclosed, the method including adding an ant pheromone to an ant bait to form a pheromone-assisted bait; and attracting a target species to a treatment area using the pheromone-assisted bait.

### CROSS-REFERENCE TO RELATED APPLICATION

This application claims priority to U.S. Patent Provisional Application No. 61/939,421, filed Feb. 13, 2014, which is incorporated herein by this reference in its entirety.

### TECHNICAL FIELD

The present invention pertains to the development of pheromone-assisted techniques (PAT) to improve efficacy of insecticide baits targeting urban pest ant species, and more particularly, to improve the efficacy and target specificity of existing insecticide bait methods for pestiferous ants by exploiting the target species' innate trail following behavior, while simultaneously providing environmentally and economically favorable integrated pest management (IPM) strategies.

### BACKGROUND

Ants rank as one of the most important pests in the structural pest control industry, with an estimated $1.7 billion spent annually for their control by pest management professionals (PMPs) in the United States (Knight and Rust 1990, Curl 2005). Commercial pest control companies in California report that 65-80% of their pest control services concern pest ants (Field et al. 2007). A survey by one pest management company reported that 36% of all customer calls concerned ant control, equaling the combined total for the next three pests (cockroaches, spiders, and bees). A telephone survey in northern California indicated that ants are the most common pest group encountered by homeowners and PMPs (Flint 2003).

Control strategies for urban pest ants have primarily focused on the application of barrier sprays, granules, and baits (Rust 2001, Rust et al. 2003, Silverman and Brightwell 2008). Even with recent advances in bait technologies (Klotz et al. 2003), residual insecticide barriers are still widely used by PMPs to control urban pest ants (Rust et al. 2003, Klotz et al. 2008). In particular, various pyrethroids such as bifenthrin, cyfluthrin, cypermethrin, permethrin, and fipronil (phenylpyrazole) are among the most common insecticides used by homeowners and PMPs to control ants in urban areas. For instance, the amount of permethrin used for structures and landscape maintenance, as reported by licensed applicators, increased from 70,185 kg (active ingredient) in 1997 to 119,508 kg in 2007. Over the same time period, bifenthrin use increased from 40 to 22,025 kg, and cypermethrin use increased from 41,188 to 88,272 kg (CDPR 2008). Similarly, after its registration in 1996 in California, the use of fipronil reached 29,374 kg per year in 2007 (CDPR 2008). In fact, fipronil (Termidor) has become one of the primary insecticides applied around structures for pest insects (Greenberg et al. 2010).

Consequently, pyrethroids, fipronil, and their toxic degradation products are appearing in urban waterways and aquatic sediments (Lao et al. 2010, Delgado-Moreno et al. 2011). For example, in California, bifenthrin was identified as the primary causative agent of toxicity to an indicator species, the amphipod Hyalella azteca, with additional toxicity from cyfluthrin and cypermethrin (Weston et al. 2005). Hyallela azteca is a standard, lower food-chain organism used to determine the non-target effects of pesticide contaminants. Application of insecticides around structures to control ants and other pests by PMPs and homeowners was recognized as a major source of insecticides in urban waterways (Weston et al. 2009). Given the amount of insecticides applied to urban settings for ant control and their impact on urban waterways, development of alternative IPM strategies is critical to decrease the overall amounts of insecticides applied, while still achieving effective control of target ant species.

Insect pheromones have great potential to be exploited in the development of effective IPM programs because of their strong and direct effect on the target pests' behavior, even at extremely low application rates. Furthermore, their species-specificity and lack of toxicity make them ideal tools for developing alternative pest management strategies that minimize non-target impacts. However, the use of insect pheromones for IPM has been typically limited to detection, monitoring, mass trapping, and mating disruption with synthetic sex or aggregation pheromones, with most applications targeting flying insects.

Social insects such as ants, honeybees, and termites use a diverse array of pheromones for organization and coordination of all aspects of their colony development and maintenance, including defense, reproduction, foraging, and nest relocation (Hölldobler and Wilson 1990, Vander Meer et al. 1998). In particular, trail pheromones of ants are known to play critical roles in their foraging and nest relocation activities (Hölldobler and Wilson 1978, Hölldobler and Wilson 1990, Wilkins et al. 2006, Witte et al. 2007, Cao and Dornhaus 2012).

Several studies by other researchers have explored the possibility of using synthetic trail pheromones to develop practical management strategies for the Argentine ant, Linepithema humile. For example, one study suggested that (Z)-9-hexadecenal, a putative trail pheromone component for Argentine ants, might increase the consumption of sugar-based liquid baits by these ants when it is mixed with the baits (Greenberg and Klotz 2000). However, this study did not use a toxicant or insecticide with the pheromone compound. Several studies have been conducted in Japan and Hawaii to test whether the application of synthetic (Z)-9-hexadecenal can disrupt trail formation and foraging activity of Argentine ant populations in the field (Suckling et al. 2008, 2010, Tanaka et al. 2009, Nishisue et al. 2010, Sunamura et al. 2011). These experiments found that attempted disruption of foraging with even relatively large quantities of synthetic (Z)-9-hexadecenal had negligible impact on Argentine ant populations when used as a stand-alone treatment (Nishisue et al. 2010), but produced a significant effect when used in conjunction with toxic baits separately applied in the field (Sunamura et al. 2011). Extermination of ants by the insecticidal bait coupled with inhibition of re-infestation by disruption of foraging by the applied (Z)-9-hexadecenal were attributed as possible mechanisms of the combination effect. These studies have only focused on “disrupting” trails by applying a large amount of synthetic pheromone in the environment.

### SUMMARY

A method of improving efficacy of an ant bait is disclosed, the method comprising: adding an ant pheromone to an ant bait to form a pheromone-assisted bait; and attracting a target species to a treatment area using the pheromone-assisted bait.

A system for improving efficacy of an ant bait is disclosed, the system comprising: an ant pheromone, and an ant bait, wherein the ant pheromone is added to the ant bait to form a pheromone-assisted bait; and a target species of ants, which is attracted to a treatment area using the pheromone-assisted bait.

### BRIEF DESCRIPTION OF THE DRAWINGS

FIG. 1 shows a total number of Argentine ants feeding (mean±SEM) at the bait dish containing thiamethoxam gel bait, wherein C, control, gel bait only; PAT, Pheromone-Assisted Technique (gel bait+pheromone).

FIG. 2 shows a cumulative mortality (mean±SEM) of Argentine ant at day 7, wherein C, control, gel bait only; PAT, Pheromone-Assisted Technique (gel bait+pheromone).

FIG. 3 shows a total number of Argentine ants feeding (mean±SEM) at the bait dish containing fipronil gel bait, wherein C, control, gel bait only; PAT, Pheromone-Assisted Technique (gel bait+pheromone).

FIG. 4 shows a total amount of gel bait consumed by foraging ants (mean±SEM) at weekly monitoring.

FIG. 5 shows a comparison between gel bait only and pheromone+gel bait treatments, wherein post-treatment activity levels are expressed as proportions of corresponding pre-treatment activity levels. The data is averaged from five houses per treatment. Asterisks indicate that there is significant difference in ant foraging activity between gel bait only and pheromone+gel bait treatments (Wilcoxon Rank Sum Test: α=0.05).

### DETAILED DESCRIPTION

Because some pestiferous ants exhibit strong innate trail-following responses, their trail pheromones and other attractant pheromones can have great potential for attracting target ant species to the insecticidal baits. Current control measures for urban pest ants typically include perimeter applications of insecticides around structures, resulting in problems with insecticide runoff and environmental contamination. On other hand, insecticidal baits are available, and these liquid or gel baits are largely considered as target-specific control technologies with non-target impact and environmental contamination. However, baiting technologies are typically labor intensive and the baits placed outdoor environment tend to quickly lose their palatability for target ant species primarily because of high temperature and low humidity. In accordance with an exemplary embodiment, a method and system of combining the attractant pheromone of ants and existing baiting techniques (liquid, gel) are disclosed.

With this technique, the following can be achieved:

(1) increase the chance of initial discovery of the bait by foragers by actively attracting them from their existing foraging trails to the baits;
(2) increase the consumption amount by foraging ants; and
(3) maximize the efficacy of the baits applied in an outdoor environment.

In accordance with an exemplary embodiment, the disclosure focuses on using a very small amount of pheromone to attract the target ant species to the toxic baits. The response of the insect to the pheromone compound can be highly dependent on the concentration. In previous trials, the optimal concentration of the pheromone (extremely low concentration, not detectible to human) to be used with insecticidal baits has been discovered.

In accordance with an exemplary embodiment, a total of three studies have been conducted to empirically support the current disclosure. In accordance with an exemplary embodiment, two ant gel baits that are broadly marketed throughout US for residential pest ant control were of particular interest. These two gel baits are different in their active ingredients; one with thiamethoxam and the other with fipronil. Experiment #1 was conducted in the laboratory to determine whether the synthetic pheromone will increase Argentine ants' foraging on a thiamethoxam gel bait and its resulting efficacy. Experiment #2 was conducted in the laboratory to determine whether the synthetic pheromone will increase Argentine ants' foraging on a fipronil gel bait. In Experiment #3, based on the field study, it is demonstrated that the addition of the pheromone in the thiamethoxam gel bait increased the consumption of the bait by ants, and the increased consumption was translated into improved efficacy against field populations of Argentine ants.

### Experiment #1

### Will the Synthetic Pheromone Increase Ants' Foraging on a Thiamethoxam Gel Bait and its Resulting Efficacy?

In accordance with an exemplary embodiment, a laboratory study was conducted to determine if the efficacy of a thiamethoxam gel bait can be improved by incorporating a synthetic attractant pheromone with the bait matrix. Argentine ants were collected from a citrus grove (biological control grove) on the University of California, Riverside, campus. Ant nests were excavated from the ground and transported to a laboratory chamber where they were extracted from the soil. Laboratory stock colonies were maintained in plastic boxes (26.5 by 30 by 10 cm) with the inner sides coated with Teflon (Fluoropolymer resin, type 30, DuPont Polymers) to prevent ants from escaping. Each colony was provided with two or three artificial nests constructed from plaster-filled petri dishes (9 cm in diameter by 1.5 cm in depth) formed with a 5-cm-diameter by 1-cm-deep cylindrical area in the center of the dish to serve as a nesting space. In addition to continuous access to water in a test tube, the colonies were provisioned with fresh water, 25% (wt:vol) sucrose water, and freshly killed American cockroaches (Periplaneta americana) three times a week.

Argentine ants from stock laboratory colonies were anesthetized with CO₂ and placed in an empty plastic box with the sides coated with Teflon. This pooling process minimizes any possible effect of colonial difference. In accordance with an exemplary embodiment, 0.5 g of ants from the box were aspirated and transferred into a test colony box (20 by 35 cm). Aspirating anaesthetized ants resulted in relatively similar-sized colonies with brood as well as workers and reproductives. For example, with eighteen replications, the average total number of ants in a colony was 758±16.5 (mean±SEM, n=18, range 639-901). All of the experimental colonies were provided with at least one queen. The test colony box was provided with one artificial nest constructed from a plastic culture tube (50 ml) filled with 15-ml water and stopped with a cotton ball, and a small plastic dish with 25% sugar water applied to a small piece of cotton. The nest tube was placed near one side of the box and the sugar water dish was placed next to the nest.

The following was tested: (a) pheromone+gel bait [pheromone-assisted gel bait], and (b) gel bait only [control]. The gel bait [approximately 0.4 g of Optigard ant gel bait (0.01% thiamethoxam; Syngenta Crop Protection, Inc. Greensboro, N.C.)] was provided to the ant colony on a small plastic dish placed in the colony box bottom at the opposite side of the nest tube. For (a) pheromone+gel bait, 0.1 μg of (Z)-9-hexadecenal dissolved in 10 μl of acetone was applied on the dish and solvent was allowed to completely evaporate before adding the gel bait in the dish. The application resulted in a rate of approximately 14-16 ng per cm² for (Z)-9-hexadecenal on the bait dish bottom. For (b) gel bait only, 10 μl of clean acetone was applied on the dish before adding the gel bait.

The number of ants feeding on the gel baits on the dish was counted every 3 min for 30 min post-treatment using photographs (10 observations). The study was replicated 12 times per treatment. The count values from the 10 observations for each replication was average, and the average values were compared between treatment and control patch with a Wilcoxon Rank Sum Test (Analytical Software 2008).

The treated colonies were maintained for 7 d at 21-25° C. and 34-45% relative humidity. The dead ants were removed from the colony box and counted daily. The total numbers of dead ants at day 7 post-treatment were compared between treatments with a one-way ANOVA followed by a Two-Sample t Test (Analytical Software 2008).

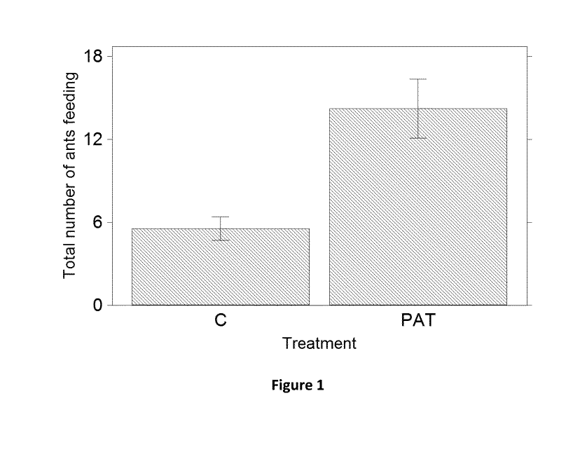

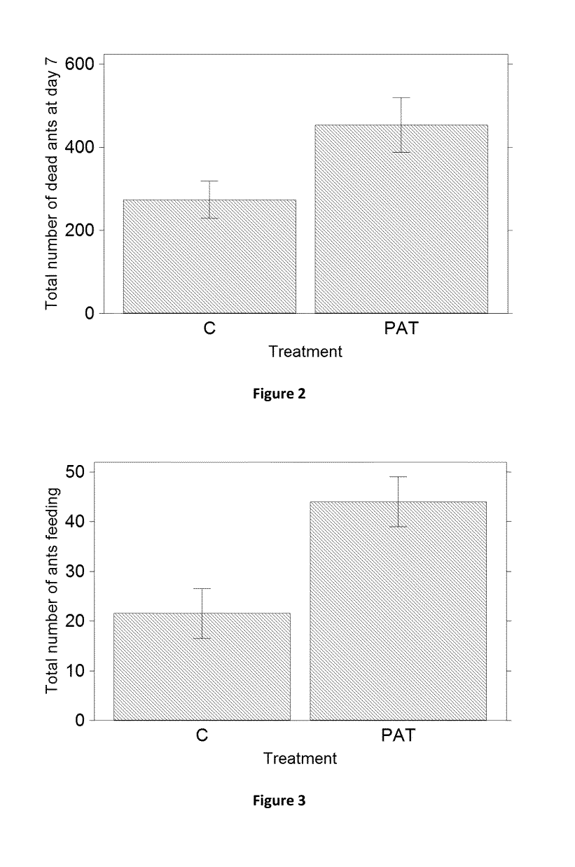

The overall number of ants feeding on the “pheromone-assisted gel bait” was significantly higher than that for the “gel bait only” control (Wilcoxon Rank Sum Test; Z=3.148, P=0.0016). The average number of ants feeding on the pheromone-assisted and control gel baits were 14.2±2.1 vs. 5.6±0.8 (mean±SEM, n=12), respectively (FIG. 1). The “pheromone-assisted gel bait” treatment also resulted in significantly higher day 7 accumulative mortality compared to the “gel bait only” control (Two-Sample t Test; t. 2.26, df=22, P=0.0341). The average mortalities of ant colonies receiving the pheromone-assisted gel bait and gel bait only control were 453.4±65.8 and 273.3±44.9 (mean±SEM, n=12), respectively (FIG. 2).

### Experiment #2

### Will the Synthetic Pheromone Increase Ants' Foraging on a Fipronil Gel Bait?

The following was tested: (a) pheromone+gel bait [pheromone-assisted gel bait], and (b) gel bait only [control]. The gel bait [≈0.4 g of Maxforce FC ant killer (0.001% fipronil; Bayer Environmental Science, Research Triangle Park, N.C.)] was provided to the ant colony on a small plastic dish placed in the colony box bottom at the opposite side of the nest tube. For (a) pheromone+gel bait, 0.1 μg of (Z)-9-hexadecenal dissolved in 10 μl of acetone was applied on the dish and solvent was allowed to completely evaporate before adding the gel bait in the dish. The application resulted in a rate of approximately 14-16 ng per cm² for (Z)-9-hexadecenal on the bait dish bottom. For (b) gel bait only, 10 μl of clean acetone was applied on the dish before adding the gel bait.

The number of ants feeding on the gel baits on the dish was counted every 3 min for 30 min post-treatment using the photographs (10 observations). The study was replicated 10 times per treatment. The count values from the 10 observations for each replication was averaged, and the average values were compared between treatment and control patch with a Wilcoxon Rank Sum Test (Analytical Software 2008).

The overall number of ants feeding at the “pheromone-assisted gel bait” were significantly higher than that for the “gel bait only” control (Wilcoxon Rank Sum Test; Z=2.684, P=0.0073). The average number of ants feeding on the pheromone-assisted and control gel baits were 44.0±5.0 vs. 21.5±5.0 (mean±SEM, n=10), respectively (FIG. 3).

### Experiment #3

### Will the Pheromone-Assisted Technique (PAT) Improve the Consumption and Efficacy of a Thiamethoxam Gel Bait Applied in the Field Targeting Argentine Ant Populations Around Residential Settings?

In this field experiment, the disclosure tested if the addition of the pheromone will enhance the efficacy of the gel bait targeting field populations of Argentine ants. Homeowners in Riverside were solicited for the project by circulating a flyer and making telephone calls (e.g., contacting previous volunteers, etc.). Prior to placement of bait stations, the houses were monitored for ant numbers. 15 ml falcon tubes filled with 12 ml of 25% sugar solution were used to monitor ant activity levels. Ten (10) monitors were placed near the house, and the other ten were placed away from the house along the perimeter fence. After 24 hours, the vials were sealed and returned to the laboratory and weighed. Loss of liquid (for example, weight) from the tubes was corrected for evaporation and drowned ants. The adjusted weight loss value made it possible to estimate the number of ant visits per station, and to map areas of greatest foraging. There is a direct relationship between amount of sugar water consumed and the number of ant visits and the number of ants in the area. Lower numbers of visits represent lower overall ant numbers. The number of ant visits was calculated by dividing the consumption (g) by 0.0003 g/visit, a single Argentine ant consuming 0.0003 g of sucrose water per visit (Reierson et al. 1998). One advantage of such monitoring is that it reflects long-term foraging (for example, 24 hours) and does not depend on singular momentary observations that may vary greatly with time of day or weather. Only residences in which there was initially significant ant feeding were used in the study. In accordance with an exemplary embodiment, the test generally aimed for at least 84 ml consumption for the 10 monitoring vials.

A total of 10 houses were used in this study. A thiamethoxam gel bait (Optigard ant gel bait, 0.01% thiamethoxam) was used as a toxic bait. Five houses were treated with the gel bait with pheromone and the other 5 houses were treated with the gel bait only. Bait stations were made from 15-ml plastic culture tube with a 3-mm hole in the cap. This allows access by the foraging ants but prevents non-target organisms from accessing the gel bait in the tube. Each bait station was loaded with 2 g of thiamethoxam gel bait. For the pheromone+gel bait treatment, 0.1 μg of (Z)-9-hexadecenal dissolved in 10 μl of acetone was applied on the gel bait, then mixed in. The mixing process included tapping the falcon tube so that the gel bait would uniformly rest at the bottom of the bait stations. For the gel bait only control, gel bait from the tube was directly used without any other chemicals added. 20 bait stations were labeled and buried around the house. The bait stations were checked every week for 4 weeks, and the ones with significant consumption were replaced with fresh bait stations. The reduction of bait station weight from weekly checks was used to estimate the consumption of the gel bait by foraging Argentine ants. The data from 20 monitoring stations were averaged per house per day, and the average values were used as representative data.

The homes were monitored 1 week before the treatment and 1, 2, and 4 weeks after the treatment. The numbers of ant visits from 20 monitoring stations were averaged per house per date, and the average values were used as representative data. Because we had five houses per treatment, each treatment resulted in five data points per date. The percent reduction of foraging activity was calculated per house per date per treatment based on the initial pre-treatment data. Because different houses had different levels of ant foraging activity, the post-treatment data were standardized for statistical analysis by converting them to the proportions of their own initial pre-treatment values. The proportion data on each day (i.e., 1, 2, and 4 week post treatment) were compared between pheromone+gel bait vs. gel bait only using a nonparametric Wilcoxon Rank Sum Test with α=0.05.

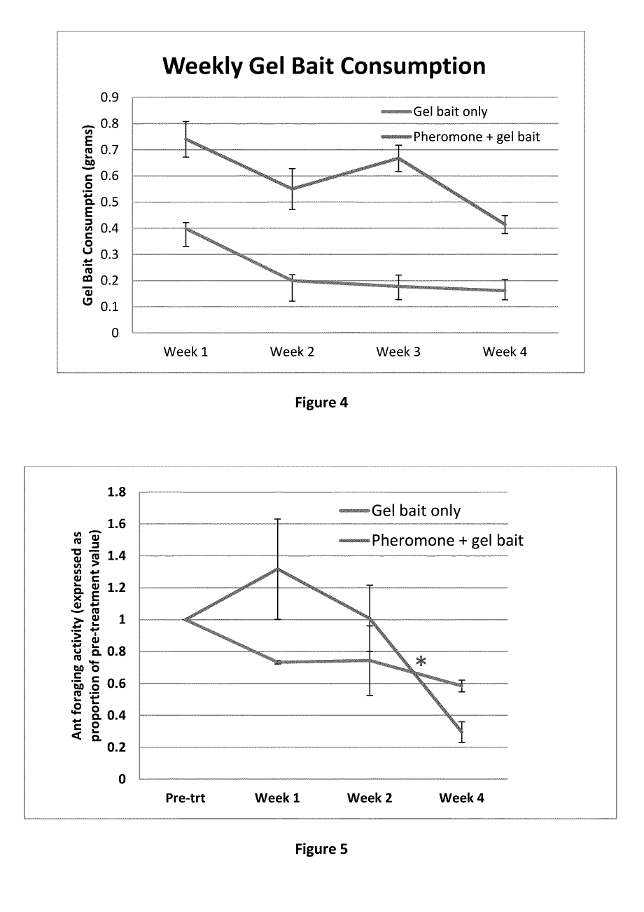

The weekly consumption of “pheromone-assisted gel bait” was significantly higher than that for “gel bait only” control at weeks 1, 2, 3, and 4 (Wilcoxon Rank Sum Test; P<0.05 for all). Based on the pooled data from the study, the addition of the pheromone increased the consumption of the gel bait by 150% compared to the gel bait only control [i.e., 0.59±0.04 g and 0.23±0.03 g (mean±SEM) for pheromone+gel bait and gel bait only, respectively] (FIG. 4).

The pheromone+gel bait and gel bait only treatments were not different in their levels of ants' foraging activities at weeks 1 and 2 (Wilcoxon Rank Sum Test; P>0.1). At week 4, however, the levels of foraging activity were significantly lower in the pheromone+gel bait treatments compared to the gel bait only controls (Wilcoxon Rank Sum Test; Z=2.298, P=0.0216) (FIG. 5). At week 4, the pheromone+gel bait provided about 71% reduction in ant foraging activity while the gel bait only control provided average of 42% reduction.

The concentration of the pheromone in the final insecticide preparation is critical to achieve its desired effect (i.e., attraction to the toxic bait). In addition, the stability of the pheromone can be negatively affected if it is mixed with the insecticide formulation and then stored for a long time. Because of these reasons, the best way of practicing the invention will be developing effective pheromone and insecticide mixture formulations. For example, the pheromone (z)-9-hexadecenal could be microencapsulated to be mixed with the insecticidal paste or gel.

With this invention, insecticidal baits will attract the target ant species (in this case, Argentine ants). In addition, the insecticidal baits, which are placed slightly away from their targets (for example, existing trails or nest entrances) will still control ants because the pheromone attracts them. As a result, the amount of insecticide that is necessary to get effective control can be greatly reduced. Pest control professionals can also apply insecticidal bait+pheromone in a targeted manner (e.g., nest entrance or active trails), further reducing the quantity of insecticide applied in the environment.

In accordance with an exemplary embodiment, only 1 μg of pheromone per 2 g of insecticidal gel bait was used. Considering the quantity of the gel bait in the commercial container of the gel bait (27-30 g), the total amount of pheromone required per tube would be approximately 15 μg. This means that >66,000 bait tubes can be prepared with 1 g of synthetic pheromone. Because the current price of the synthetic pheromone is relatively low ($36.76 for 1 g), and pest control companies or homeowners can reduce the cost by decreasing the use of active ingredient in the baits, the current invention of pheromone-assisted technique is cost-effective.

The idea of mixing trail pheromones or other attractant pheromones with insecticidal bait can be modified in several ways. First, the pheromone compounds can be used in gel bait. Second, the pheromone compounds can be used with granular bait. Third, the pheromone compounds can be used with liquid bait. Lastly, the pheromone compounds can be used with other baiting techniques that are not included in this invention (for example, polyachrylamide hydrogel matrix as liquid bait dispenser).

Advantages of these techniques would be as follows: (1) Foragers will discover insecticidal baits quickly before degradation of the active ingredients or chemical/physical changes of bait matrices occur, thus efficacy of the baits will be maximized; and (2) Ant control programs can be designed to be more species-specific by attracting particular target species or groups of related species to the insecticidal baits, while having little or no effect on other non-target ants or other invertebrates.

In accordance with an exemplary embodiment, the disclosure improves current insecticidal baiting practices by improving (1) efficacy and (2) target specificity (pheromones are species-specific). The disclosure will also help reduce the overall amount of insecticide applied in the environment and therefore reduce the unintended contamination of urban waterways with insecticides.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of improving efficacy of an ant bait, the method comprising:
adding an ant pheromone to an ant bait to form a pheromone-assisted bait; and
attracting a target species to a treatment area using the pheromone-assisted bait.

2. The method of claim 1, comprising:
exposing the target species to the pheromone-assisted bait at the treatment area.

3. The method of claim 1, wherein the pheromone-assisted bait is a pheromone-assisted gel bait.

4. The method of claim 1, wherein the pheromone-assisted bait is a pheromone-assisted liquid bait.

5. The method of claim 1, wherein the pheromone-assisted bait is a pheromone-assisted granular bait.

6. The method of claim 1, wherein the ant pheromone is a synthetic pheromone.

7. The method of claim 1, comprising:
using an amount of a concentrated pheromone, which is not detectible to a human.

8. The method of claim 1, wherein the pheromone is (Z)-9-hexadecenal and the bait is thiamethoxam and/or fipronil.

9. The method of claim 1, wherein the pheromone is configured to target one or more species of ants.

10. A system for improving efficacy of an ant bait, the system comprising:
an ant pheromone, and an ant bait, wherein the ant pheromone is added to the ant bait to form a pheromone-assisted bait; and
a target species of ants, which is attracted to a treatment area using the pheromone-assisted bait.

11. The system of claim 10, wherein the pheromone-assisted bait is a pheromone-assisted gel bait.

12. The system of claim 10, wherein the pheromone-assisted bait is a pheromone-assisted liquid bait.

13. The system of claim 10, wherein the pheromone-assisted bait is a pheromone-assisted granular bait.

14. The system of claim 10, wherein the ant pheromone is a synthetic pheromone.

15. The system of claim 10, comprising:
an amount of a concentrated pheromone, which is not detectible to a human.

16. The system of claim 10, wherein the pheromone is (Z)-9-hexadecenal and the bait is thiamethoxam and/or fipronil.
